(19) United States
(12) Patent Application Publication
(10) Pub. No.: US 2018/0031911 A1
(43) Pub. Date: Feb. 1, 2018

(54) MANUFACTURE METHOD OF QUANTUM DOT COLOR FILM SUBSTRATE

(71) Applicant: Shenzhen China Star Optoelectronics Technology Co. Ltd., Shenzhen City (CN)

(72) Inventor: Guohe Liu, Shenzhen City (CN)

(21) Appl. No.: 14/914,645

(22) PCT Filed: Dec. 23, 2015
(86) PCT No.: PCT/CN2015/098471

§ 371 Date: Feb. 26, 2016

(30) Foreign Application Priority Data
Nov. 30, 2015 (CN) 201510860705.5

(51) Int. Cl. G02F 1/1335

(52) U.S. Cl. CPC G02F 1/133516; G02F 1/133621; G02F 1/133514; G02F 1/133617; G02F 2202/36; G02F 2202/10; G02F 2001/133614; G02F 1/1368

(57) ABSTRACT

The disclosure provides a manufacture method of a quantum dot color film substrate, a high precision quantum dot pattern is formed utilizing a property of moisture varied layer of a photocatalyst achieving better moisture after being radiated by ultraviolet light, manufacture process of a quantum dot pattern is simplified as well as enhancing precision of quantum dot layer pattern, and consuming less quantum dot materials and costs, produced quantum dot color film substrate can improve color saturation and gamut of a display device efficiently, reinforcing color display ability of a display panel

### FIELD OF THE DISCLOSURE

The present disclosure relates to a display technology field, and more particularly to a manufacture method of a quantum dot colorfilm substrate.

### BACKGROUND OF THE DISCLOSURE

With the development of the display technology, much emphasis has been laid upon display quality of a display device. Quantum dots (QDs) can be spherical or roundish semiconductor nanoparticles consisting of elements of II-VI group or III-V group, whose sizes can be between 0 to 100 nanometers. Quantum dots show quantum confinement effect as sizes of particles are smaller than Bohr radius of exciton of corresponding bulk material, the energy level structure changes from quasi continuousness of bulk material to discrete structure of quantum dot material, which leads to quantum dots show a specific property that can be lit by radiation. Widths between energy levels increase according to decreasing sizes of quantum dots, energies required to stimulate corresponding quantum dots and energies released to return to the ground state of stimulated quantum dots are ascending accordingly, resulting in stimulation of quantum dots and blue shift phenomenon of fluorescence spectrum, luminescence spectrum can cover the whole visible region by controlling sizes of quantum dots. Such as a size of cadmium selenide (CdSe) descends from 6.6 nm to 2.0 nm, the according wavelength of light from red light region 635 nm ‘blue shifts’ to 460 nm of blue light region.

Quantum dotmaterials can be applied in display devices for improving color gamut and the ability of color reproduction of display devices due to properties such as concentration in spectrum, high purity in color, adjustable color light by simply governing sizes, structures or components of quantum dots. Like a patent CN 102944943A, and a patent US20150002788A1 both provided a proposal that a quantum dot layer with a pattern structure can take the place of a color filter film to display colors, but the patents omit the method of patterning a quantum dot layer.

A patent CN103226260A provided a method that dispersing quantum dots in photoresist and patterning the quantum dot layer by the photoetching process, but as photoresist contains a variety of polymer materials such as initiation, monomers, polymers and additives, chemical conditions are complex on surfaces of quantum dots, which can influence light emitting efficiency of quantum dots significantly. Besides the method above, quantum dot patterns can be prepared by other methods like transfer printing and screen printing, but quantum dot patterns prepared by transfer printing are low in resolution, edges of the patterns are serration, and adhesion of a quantum dot layer and a matrix has room for improvement; a method of preparing quantum dot layers by an ink-jet printer requires high quality of a ink-jet print device, QDs are sensitive to the environment, especially water and oxygen, which can easily affect light emitting efficiency and lifetime. Glues can be applied to coat QDs to avoid the influence from outside, an insulating layer is coated on surfaces of QDs to protect QDs. Quality controls that consistence of ink drops and accuracy of printed patterns are still technical barriers for mass production.

### SUMMARY OF THE DISCLOSURE

The objective of the present disclosure is to provide a manufacture method of a quantum dot color film substrate, a high precision quantum dot pattern is formed utilizing a property of moisture varied layer of a photocatalyst achieving better moisture after being radiated by ultraviolet light, manufacture process is simplified and quantum dot layer pattern precision is enhanced.

The present disclosure provides a manufacture method of a quantum dot color film substrate to chase the purpose above, including steps as follows:

step 1, providing a color film substrate, the color film substrate including a base substrate, a black matrix on the base substrate, and color filter layers, the color filter layers includes a red color block layer, a green color block layer, and a transparent light block layer;

step 2, providing a moisture varied agent, the moisture varied agent includes following ingredients: a photocatalyst, organic polysiloxane, and a solvent; coating a layer of moisture varied agent on the black matrix and the color filter layer, vacuum desiccation processing the moisture varied agent to remove the solvent, obtaining a moisture varied layer;

step 3, providing a light shelter, exposing the moisture varied layer under ultraviolet light with assistance of the light shelter, sections of the light shelter corresponding to the red color block layer and the green color block layer are transparent, a first section of the moisture varied layer corresponding to the red color block layer and the green color block layer are radiated by ultraviolet light in the step to stimulate a reaction inside, which can enhance a property of moisture, a section on the light shelter corresponding to the transparent light block layer is opaque, a second section of the moisture varied layer corresponding to the transparent light block layer is insulated from ultraviolet radiation, which has no variation in moisture;

step 4, painting a layer of quantum dot coating liquid on the moisture varied layer, the quantum dot coating liquid includes following ingredients: quantum dots, a quantum dot ligand coordinating with surfaces of quantum dots, a solvent, and an additive; as moisture of the first section of the moisture varied layer is improved by ultraviolet radiation, correspondingly, moisture property of the first section is better than that of the second section of the moisture varied layer, a large scale of moisture angle of the quantum dot coating liquid on a surface of the second section of the moisture varied layer cannot be moistened sufficiently, yet the quantum dot coating liquid on a surface of the first section of the moisture varied layer can be moistened sufficiently, the layer of quantum dot coating liquid distributes on the first section of the moisture varied layer rather than remaining on the second section of the moisture varied layer due to existence of gravity to form a quantum dot pattern;

step 5, heating quantum dot coating liquid that forms the quantum dot pattern to be solid, obtaining a patterned quantum dot layer;

step 6, forming a transparent conductive layer on the quantum dot layer; completing manufacture of a quantum dot color film substrate.

In the moisture varied agent, the photocatalyst is TiO₂, ZnO, or SnO₂, a particle size of the photocatalyst is 10-50 nm.

In the moisture varied agent, the organic polysiloxane is polysioxane containing a fluorin alkyl group.

In the moisture varied agent, the solvent is one or more of methanol, ethanol, isopropanol, acetone, ethyl glycol dimethyl ether, ethylene glycol monoethyl ether, methyl acetate, ethyl acetate, butyl acetate, methylbenzene, dimethyl benzene.

In the quantum dot coating liquid, the quantum dot is a core-shell structure, materials of the quantum dots derive from semiconductor materials of II-VI group, semiconductor materials of III-V group, and nanometer semiconductor materials of IV-VI group.

In the quantum dot coating liquid, particle sizes of the quantum dots are 1-10 nm.

In the quantum dot coating liquid, the quantum dot ligand is tri-n-octylphosphine, or tri-n-octyl phosphine oxide.

In the quantum dot coating liquid, the solvent is one or more of dimethyl benzene, methylbenzene, cyclohexyl benzene, trimethylbenzene, pyridine, pyrrole, hexane, pentane, cyclohexane.

In the quantum dot coating liquid, the quantum dots include red quantum dots that emit red light and green quantum dots that emit green light.

The quantum dot color film substrate achieved in the step 6 is applied in a display device with blue backlight.

The disclosure likewise provides a manufacture method of a quantum dot color film substrate, including following steps:

step 1, providing a color film substrate, the color film substrate includes a base substrate, a black matrix on the base substrate, and color filter layers, the color filter layers include a red color block layer, a green color block layer, and a transparent light block layer;

step 2, providing a moisture varied agent, the moisture varied agent includes following ingredients: a photocatalyst, organic polysiloxane, and a solvent; coating a layer of moisture varied agent on the black matrix and the color filter layer, vacuum desiccation processing the moisture varied agent to remove the solvent, obtaining a moisture varied layer;

step 3, providing a light shelter, exposing the moisture varied layer under ultraviolet light with assistance of the light shelter, sections of the light shelter corresponding to the red color block layer and the green color block layer are transparent, a first section of the moisture varied layer corresponding to the red color block layer and the green color block layer is radiated by ultraviolet light in the step to stimulate a reaction inside, which can enhance a property of moisture, a section on the light shelter corresponding to the transparent light block layer is opaque, a second section of the moisture varied layer corresponding to the transparent light block layer is insulated from ultraviolet radiation, which has no variation in moisture;

step 4, painting a layer of quantum dot coating liquid on the moisture varied layer, the quantum dot coating liquid includes following ingredients: quantum dots, a quantum dot ligand coordinating with surfaces of quantum dots, a solvent, and an additive; as moisture of the first section of the moisture varied layer is improved by ultraviolet radiation, correspondingly, moisture property of the first section is better than that of the second section of the moisture varied layer, a large scale of moisture angle of the quantum dot coating liquid on a surface of the second section of the moisture varied layer cannot be moistened sufficiently, yet the quantum dot coating liquid on a surface of the first section of the moisture varied layer can be moistened sufficiently, the layer of quantum dot coating liquid distributes on the first section of the moisture varied layer rather than remaining on the second section of the moisture varied layer due to existence of gravity to form a quantum dot pattern;

step 5, heating quantum dot coating liquid that forms the quantum dot pattern to be solid, obtaining a patterned quantum dot layer;

step 6, forming a transparent conductive layer on the quantum dot layer; completing manufacture of a quantum dot color film substrate;

In the moisture varied agent, the photocatalyst is TiO₂, ZnO, or SnO₂, a particle size of the photocatalyst is 10-50 nm.

In the moisture varied agent, the organic polysiloxane is polysioxane containing a fluorin alkyl group.

In the moisture varied agent, the solvent is one or more of methanol, ethanol, isopropanol, acetone, ethyl glycol dimethyl ether, ethylene glycol monoethyl ether, methyl acetate, ethyl acetate, butyl acetate, methylbenzene, dimethyl benzene.

The quantum dot color film substrate achieved in the step 6 is applied in a display device with blue backlight.

Advantages of the disclosure: the disclosure provides a manufacture method of quantum dot color film substrate, a high precision quantum dot pattern is formed utilizing a property of moisture varied layer of a photocatalyst achieving better moisture after being radiated by ultraviolet light, manufacture process is simplified and quantum dot layer pattern precision is enhanced, the manufacture is easily processed, and less quantum dot materials will be consumed, which means costs can be reduced, produced quantum dot color film substrate can improve color saturation and gamut of a display device efficiently, reinforcing color display ability of a display panel.

### BRIEF DESCRIPTION OF THE DRAWINGS

Embodiments of the disclosure will be described in detail and illustrated by figures to clarify the proposal and the advantages of the disclosure.

In figures,

FIG. 1 is a flow chart of a manufacture method of a quantum dot color film substrate of the present disclosure;

FIG. 2 is a diagram of step 2 of a manufacture method of a quantum dot color film substrate of the present disclosure;

FIG. 3 is a diagram of step 3 of a manufacture method of a quantum dot color film substrate of the present disclosure;

FIG. 4 is a diagram of step 4 of a manufacture method of a quantum dot color film substrate of the present disclosure;

FIG. 5 is a diagram of step 5 of a manufacture method of a quantum dot color film substrate of the present disclosure;

FIG. 6 is a diagram of step 6 of a manufacture method of a quantum dot color film substrate of the present disclosure;

FIG. 7 is a diagram of a quantum dot color film substrate applied in a display device for color display of the present disclosure.

### DETAILED DESCRIPTION OF PREFERRED EMBODIMENTS

Embodiments of the present disclosure are described in detail with the accompanying drawings to illustrate the proposal and performance as follows.

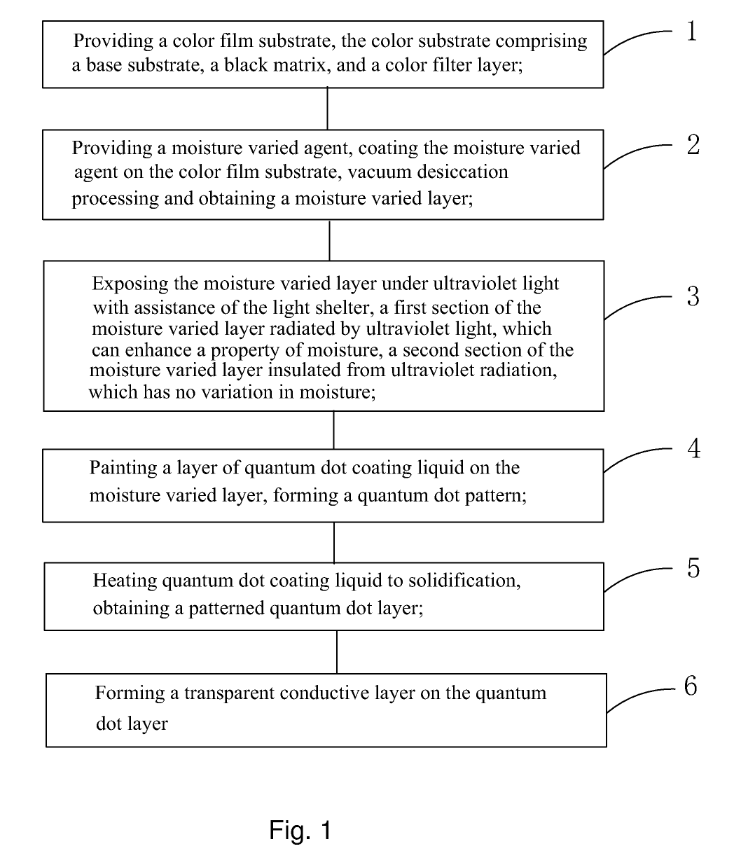

Referring to FIG. 1, the present disclosure provides a manufacture method of a quantum dot color film substrate to chase the purpose above, including steps as follows:

step 1, providing a color film substrate, the color film substrate including a base substrate 11, a black matrix 12 on the base substrate 11, and color filter layers 13, the color filter layers 13 includes a red color block layer 131, a green color block layer 132, and a transparent light block layer 133; specifically, the base substrate 11 is a glass substrate.

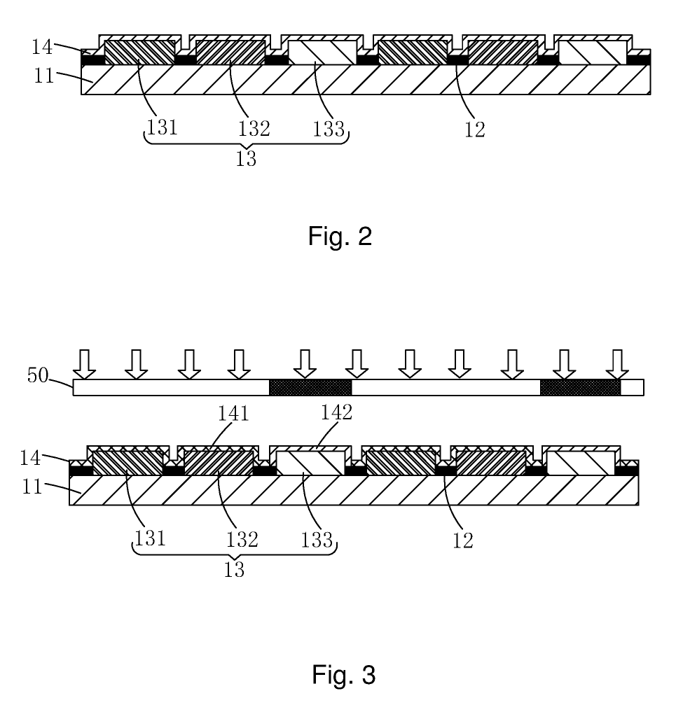

Step 2, providing a moisture varied agent, the moisture varied agent includes following ingredients: a photocatalyst, organic polysiloxane, and a solvent; as shown in FIG. 2, coating a layer of moisture varied agent on the black matrix 12 and the color filter layer 13, vacuum desiccation processing the moisture varied agent to remove the solvent, obtaining a moisture varied layer 14; specifically, in the moisture varied agent, the photocatalyst can be TiO₂, ZnO, SnO₂, or other photocatalysts, a particle size of the photocatalyst is preferably 10-50 nm; the organic polysiloxane is preferably polysioxane containing a fluorin alkyl group, the sort of polysioxane has low surface energy, which can improve liquid resistance of the moisture varied layer 14; the solvent can be one or more of methanol, ethanol, isopropanol, acetone, ethyl glycol dimethyl ether, ethylene glycol monoethyl ether, methyl acetate, ethyl acetate, butyl acetate, methylbenzene, dimethyl benzene.

step 3, as shown in FIG. 3, providing a light shelter 50, exposing the moisture varied layer 14 under ultraviolet light with assistance of the light shelter 50, sections of the light shelter 50 corresponding to the red color block layer 131 and the green color block layer 132 are transparent, a first section 141 of the moisture varied layer 14 corresponding to the red color block layer 131 and the green color block layer 132 is radiated by ultraviolet light in the step to stimulate a reaction inside, which can enhance a property of moisture, a section 52 on the light shelter 50 corresponding to the transparent light block layer 133 is opaque, a second section 142 of the moisture varied layer 14 corresponding to the transparent light block layer 133 is insulated from ultraviolet radiation, which has no variation in moisture; specifically, a principle of the first section 141 of the moisture varied layer 14 radiated by ultraviolet light in the step to stimulate a reaction inside, which can enhance a property of moisture is: a photocatalyst in the first section 141 of the moisture varied layer 14 generates an electron-vacancy couples, the electron-vacancy couples react with adjacent substance and generate active oxygen species like superoxide free radicals or hydroxyl free radicals, the active oxygen species react with polysiloxane to better the moisture property, further to better the moisture property of the first section 141 of the moisture varied layer 14.

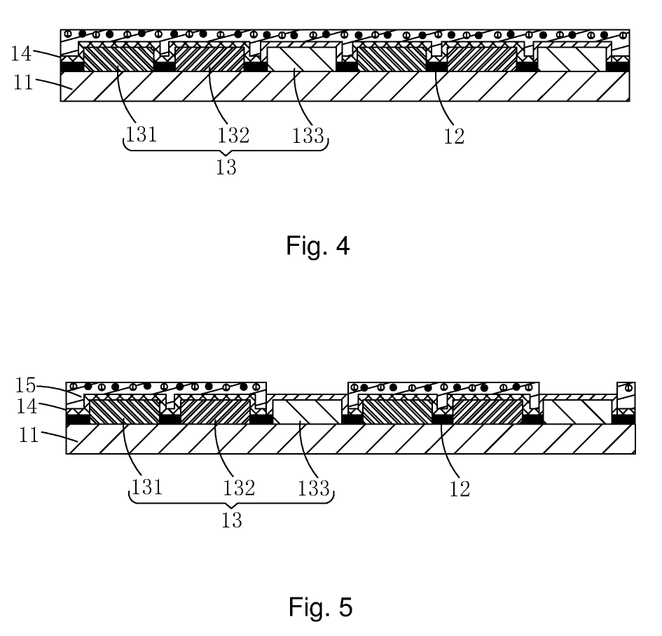

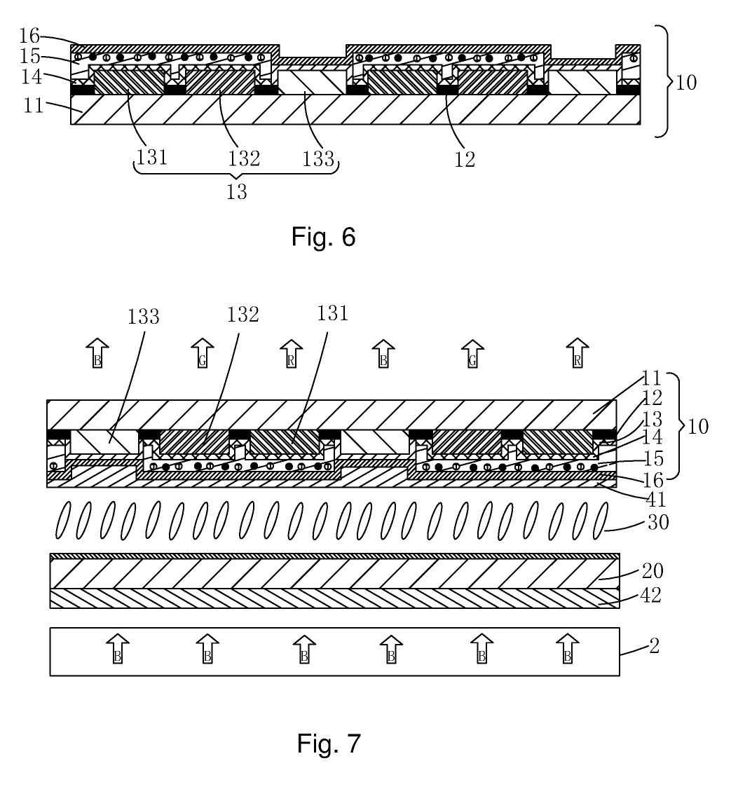

step 4, as shown in FIG. 4, painting a layer of quantum dot coating liquid on the moisture varied layer 14, the quantum dot coating liquid includes following ingredients: quantum dots, a quantum dot ligand coordinating with surfaces of quantum dots, a solvent, and an additive; as moisture of the first section 141 of the moisture varied layer 14 is improved by ultraviolet radiation, correspondingly, moisture property of the first section 141 is better than that of the second section 142 of the moisture varied layer 14, a large scale of moisture angle of the quantum dot coating liquid on a surface of the second section 142 of the moisture varied layer 14 cannot be moistened sufficiently, yet the quantum dot coating liquid on a surface of the first section 141 of the moisture varied layer 14 can be moistened sufficiently, the layer of quantum dot coating liquid distributes on the first section 141 of the moisture varied layer 14 rather than remaining on the second section 142 of the moisture varied layer 14 due to existence of gravity to form a quantum dot pattern; specifically, in the moisture varied agent, the solvent can be one or more of methanol, ethanol, isopropanol, acetone, ethyl glycol dimethyl ether, ethylene glycol monoethyl ether, methyl acetate, ethyl acetate, butyl acetate, methylbenzene and dimethyl benzene; the quantum dot is a core-shell structure, materials of the quantum dots derive from semiconductor materials of II-VI group (such as CdS, CdSe, HgTe, ZnS, ZnSe, ZnTe, HgS), semiconductor materials of III-V group (such as InP, InAs, GaP, GaAs), or nanometer semiconductor materials of IV-VI group, the most suitable particle sizes of the quantum dots above are 1-10 nm; the quantum dot ligand can be tri-n-octylphosphine (TOP), or tri-n-octyl phosphine oxide (TOPO).

Step 5, as shown in FIG. 5, heating quantum dot coating liquid that forms the quantum dot pattern to be solid, obtaining a patterned quantum dot layer 15;

step 6, forming a transparent conductive layer on the quantum dot layer; completing manufacture of a quantum dot color film substrate.

Specifically, a TFT substrate 20 is provided, an upper polarizer 41 and a lower polarizer 42 are disposed on the quantum dot color film substrate 10 and the TFT substrate 20 respectively; a quantum dot display panel can be obtained after a cell process; specifically, a structural view of the quantum dot display panel is shown in FIG. 7, including a quantum dot color film substrate 10, a TFT substrate 20 disposed opposite to the quantum dot color film substrate 10, a liquid crystal layer 30 sealed between the quantum dot color film substrate 10 and the TFT substrate 20, an upper polarizer 41 disposed one side of the quantum dot color film substrate 10, and a lower polarizer 42 disposed on one side of the TFT substrate 20; the upper polarizer 41 employs an embedded polarizer like a polarizer of dyed series, the upper polarizer 41 is disposed on a side of the quantum dot color film substrate 10 towards the TFT substrate 20; the lower polarizer 42 can be embedded or external, the lower polarizer 42 is disposed on a side of the TFT substrate towards or against the quantum dot color film substrate 10; a polarization direction of the lower polarizer 42 is perpendicular to that of the upper polarizer 41.

Specifically, in the quantum dot coating liquid, the quantum dots include red quantum dots that emit red light and green quantum dots that emit green light, which is the formed quantum dot layer 14 includes red quantum dots and green quantum dots; the quantum dot color film substrate achieved in the step 6 is applied in a display device with blue backlight, as shown in FIG. 7, when a display panel including the quantum dot color film substrate 10 is applied in a display device with blue backlight to display, a backlight module 2 emits blue backlight, the quantum dot layer 14 mixing red and green quantum dots can emit a mixture of red light and green light with narrow full width at half maximum stimulated by blue backlight, the mixed light subsequently penetrates the red color block layer 131 and the green color block layer 132 respectively, filtered to be red light with high purity and green light with high purity; the mixed light appears blue after penetrating the blue backlight due to no quantum dot layer covers on the corresponding transparent light block layer 133; all of which provide three primary colors red, green and blue for color display, color gamut exponent can be improved efficiently, and the quantum dot layer 14 does not contain blue quantum dot material, but combining blue backlight and transparent light block layer, resulting in utilizing light more efficiently with less costs in materials.

Overall, the disclosure provides a manufacture method of a quantum dot color film substrate, a high precision quantum dot pattern is formed utilizing a property of moisture varied layer of a photocatalyst achieving better moisture after being radiated by ultraviolet light, manufacture process of a quantum dot pattern is simplified as well as enhancing precision of quantum dot layer pattern, and consuming less quantum dot materials and costs, produced quantum dot color film substrate can improve color saturation and gamut of a display device efficiently, reinforcing color display ability of a display panel.

It is understandable in practical to a person skilled in the art that all or portion of the processes in the method according to the aforesaid embodiment can be accomplished with modifications and equivalent replacements, which should be covered by the protected scope of the disclosure.

What is claimed is:

1. A manufacture method of quantum dot color film substrate, comprising following steps:
step 1, providing a color film substrate, the color film substrate comprising a base substrate, a black matrix on the base substrate, and color filter layers, the color filter layers comprising a red color block layer, a green color block layer, and a transparent light block layer;
step 2, providing a moisture varied agent, the moisture varied agent comprising following ingredients: a photocatalyst, organic polysiloxane, and a solvent; coating a layer of moisture varied agent on the black matrix and the color filter layer, vacuum desiccation processing the layer of moisture varied agent to remove the solvent, obtaining a moisture varied layer;
step 3, providing a light shelter, exposing the moisture varied layer under ultraviolet light with assistance of the light shelter, wherein sections of the light shelter corresponding to the red color block layer and the green color block layer are transparent, a first section of the moisture varied layer corresponding to the red color block layer and the green color block layer are radiated by ultraviolet light in the step to stimulate a reaction inside, which can enhance a property of moisture, a section on the light shelter corresponding to the transparent light block layer is opaque, a second section of the moisture varied layer corresponding to the transparent light block layer is insulated from ultraviolet radiation, which has no variation in moisture;
step 4, painting a layer of quantum dot coating liquid on the moisture varied layer, the quantum dot coating liquid comprising following ingredients: quantum dots, a quantum dot ligand coordinating with surfaces of quantum dots, a solvent, and an additive; as moisture of the first section of the moisture varied layer is improved by ultraviolet radiation, correspondingly, moisture property of the first section is better than that of the second section of the moisture varied layer, a large scale of moisture angle of the quantum dot coating liquid on a surface of the second section of the moisture varied layer cannot be moistened sufficiently, yet the quantum dot coating liquid on a surface of the first section of the moisture varied layer can be moistened sufficiently, the layer of quantum dot coating liquid distributes on the first section of the moisture varied layer rather than remaining on the second section of the moisture varied layer due to existence of gravity to form a quantum dot pattern;
step 5, heating quantum dot coating liquid that forms the quantum dot pattern to be solid, obtaining a patterned quantum dot layer;
step 6, forming a transparent conductive layer on the quantum dot layer; completing manufacture of a quantum dot color film substrate.

2. The manufacture method of quantum dot color film substrate according to claim 1, wherein in the moisture varied agent, the photocatalyst is TiO₂, ZnO, or SnO₂, a particle size of the photocatalyst is 10-50 nm.

3. The manufacture method of quantum dot color film substrate according to claim 1, wherein in the moisture varied agent, the organic polysiloxane is polysioxane containing a fluorin alkyl group.

4. The manufacture method of quantum dot color film substrate according to claim 1, wherein in the moisture varied agent, the solvent is one or more of methanol, ethanol, isopropanol, acetone, ethyl glycol dimethyl ether, ethylene glycol monoethyl ether, methyl acetate, ethyl acetate, butyl acetate, methylbenzene, dimethylbenzene.

5. The manufacture method of quantum dot color film substrate according to claim 1, wherein in the quantum dot coating liquid, the quantum dot is a core-shell structure, materials of the quantum dots derive from semiconductor materials of II-VI group, semiconductor materials of III-V group, and nanometer semiconductor materials of IV-VI group.

6. The manufacture method of quantum dot color film substrate according to claim 5, wherein in the quantum dot coating liquid, particle sizes of the quantum dots are 1-10 nm.

7. The manufacture method of quantum dot color film substrate according to claim 1, wherein in the quantum dot coating liquid, the quantum dot ligand is tri-n-octylphosphine, ortri-n-octyl phosphine oxide.

8. The manufacture method of quantum dot color film substrate according to claim 1, wherein in the quantum dot coating liquid, the solvent is one or more of dimethyl benzene, methylbenzene, cyclohexyl benzene, trimethylbenzene, pyridine, pyrrole, hexane, pentane, cyclohexane.

9. The manufacture method of quantum dot color film substrate according to claim 1, wherein in the quantum dot coating liquid, the quantum dots comprise red quantum dots that emit red light and green quantum dots that emit green light.

10. The manufacture method of quantum dot color film substrate according to claim 9, wherein the quantum dot color film substrate achieved in the step 6 is applied in a display device with blue backlight.

11. A manufacture method of a quantum dot color film substrate, comprising following steps:
step 1, providing a color film substrate, the color film substrate comprising a base substrate, a black matrix on the base substrate, and color filter layers, the color filter layers comprising a red color block layer, a green color block layer, and a transparent light block layer;
step 2, providing a moisture varied agent, the moisture varied agent comprising following ingredients: a photocatalyst, organic polysiloxane, and a solvent; coating a layer of moisture varied agent on the black matrix and the color filter layer, vacuum desiccation processing the moisture varied agent to remove the solvent, obtaining a moisture varied layer;
step 3, providing a light shelter, exposing the moisture varied layer under ultraviolet light with assistance of the light shelter, wherein sections of the light shelter corresponding to the red color block layer and the green color block layer are transparent, a first section of the moisture varied layer corresponding to the red color block layer and the green color block layer are radiated by ultraviolet light in the step to stimulate a reaction inside, which can enhance a property of moisture, a section on the light shelter corresponding to the transparent light block layer is opaque, a second section of the moisture varied layer corresponding to the transparent light block layer is insulated from ultraviolet radiation, which has no variation in moisture;
step 4, painting a layer of quantum dot coating liquid on the moisture varied layer, the quantum dot coating liquid comprising following ingredients: quantum dots, a quantum dot ligand coordinating with surfaces of quantum dots, a solvent, and an additive; as moisture of the first section of the moisture varied layer is improved by ultraviolet radiation, correspondingly, moisture property of the first section is better than that of the second section of the moisture varied layer, a large scale of moisture angle of the quantum dot coating liquid on a surface of the second section of the moisture varied layer cannot be moistened sufficiently, yet the quantum dot coating liquid on a surface of the first section of the moisture varied layer can be moistened sufficiently, the layer of quantum dot coating liquid distributes on the first section of the moisture varied layer rather than remaining on the second section of the moisture varied layer due to existence of gravity to form a quantum dot pattern;
step 5, heating quantum dot coating liquid that forms the quantum dot pattern to be solid, obtaining a patterned quantum dot layer;
step 6, forming a transparent conductive layer on the quantum dot layer; completing manufacture of a quantum dot color film substrate;
wherein in the moisture varied agent, the photocatalyst is TiO₂, ZnO, or SnO₂, a particle size of the photocatalyst is 10-50 nm;
wherein in the moisture varied agent, the organic polysiloxane is polysioxane containing a fluorin alkyl group;
wherein in the moisture varied agent, the solvent is one or more of methanol, ethanol, isopropanol, acetone, ethyl glycol dimethyl ether, ethylene glycol monoethyl ether, methyl acetate, ethyl acetate, butyl acetate, methylbenzene, dimethylbenzene;
wherein the quantum dot color film substrate achieved in the step 6 is applied in a display device with blue backlight.

12. The manufacture method of quantum dot color film substrate according to claim 11, wherein in the quantum dot coating liquid, the quantum dot is a core-shell structure, materials of the quantum dots derive from semiconductor materials of II-VI group, semiconductor materials of III-V group, and nanometer semiconductor materials of IV-VI group.

13. The manufacture method of quantum dot color film substrate according to claim 12, wherein in the quantum dot coating liquid, particle sizes of the quantum dots are 1-10 nm.

14. The manufacture method of quantum dot color film substrate according to claim 11, wherein in the quantum dot coating liquid, the quantum dot ligand is tri-n-octylphosphine, ortri-n-octyl phosphine oxide.

15. The manufacture method of quantum dot color film substrate according to claim 11, wherein in the quantum dot coating liquid, the solvent is one or more of dimethyl benzene, methylbenzene, cyclohexyl benzene, trimethylbenzene, pyridine, pyrrole, hexane, pentane, cyclohexane.

16. The manufacture method of quantum dot color film substrate according to claim 11, wherein in the quantum dot coating liquid, the quantum dots comprise red quantum dots that emit red light and green quantum dots that emit green light.
